(19) United States
(12) Patent Application Publication
(10) Pub. No.: US 2008/0051939 A1
(43) Pub. Date: Feb. 28, 2008

(54) Apparatus for autonomous data collection and processing of fuel transactions from mobile tanker trucks

(75) Inventors: Walter Dobbins, Tallahassee, FL (US); Farrell Aultman, Tallahassee, FL (US); Mark Butsch, Tallahassee, FL (US); Rob Falkenhayn, Atlanta, GA (US); Herman Glenn, Sun Prairie, WI (US); Taylor Glenn, Sun Prairie, WI (US); Kathlyn Heilman, Tallahassee, FL (US); Mike Machie, Tallahassee, FL (US); Eric Pizon, Tallahassee, FL (US); Stephen Pollock, Tallahassee, FL (US); Jate Sujjavanich, Tallahassee, FL (US)

Correspondence Address: Ralph A. Dowell of DOWELL & DOWELL P.C., 2111 Eisenhower Ave, Suite 406, Alexandria, VA, 22314, US

(73) Assignee: SYN-TECH SYSTEMS, INC., Tallahassee, FL (US)

(21) Appl. No.: 11/783,885

(22) Filed: Apr. 12, 2007

Related U.S. Application Data
(60) Provisional application No. 60/791,197, filed on Apr. 12, 2006.

(51) Int. Cl. G05B 15/00

(52) U.S. Cl. 700/275

(57) ABSTRACT

An apparatus and method for autonomous fueling transaction data collection and processing from mobile fuel dispensing equipment. The apparatus features an intrinsically safe first programmed apparatus including a user interface, a second programmed apparatus for controlling fuel dispensing equipment, and a host computer system. The apparatus additionally includes a printer and charger/data cradles for holding the first programmed apparatus. Further, the components are in bi-directional wired or wireless communication with each other. The method involves collecting mobile fuel truck fuel authorization data, verifying fuel authorization data authorizing a fuel transaction, and providing real time fueling data to a user.

### CROSS-REFERENCE TO RELATED APPLICATIONS

This application claims priority to U.S. provisional application No. 60/791,197, which was filed on Apr. 12, 2006, and entitled “Apparatus for Autonomous Data Collection and Processing of Fuel Transactions from Mobile Tanker Trucks,” the subject matter of which is hereby incorporated by reference in its entirety.

### BACKGROUND OF THE INVENTION

1. Field of the Invention

The present invention generally involves mobile fuel dispensing and autonomous data collection and processing. More particularly, the present inventions relates to the integration of a fuel dispensing, control, and accounting apparatus and system to mobile aviation tanker trucks and aviation fueling systems.

2. Brief Discussion of the Related Art

Solid state microcontroller-based fuel control and accounting systems have been commercially available since the early 1980s. The known systems have incorporated many methods of accessing and transferring authorization data, including read-only electronic keys, read/write electronic keys, keypad entry, read-only radio frequency (“RF”) identification (“ID”) tags, read/write RF/ID Tags, magnetic stripe cards, bar code readers, and inductive coil antennae. Systems providing these means of data access are presently available from a large number of commercial companies.

Each of the known systems have been purposely designed, tailored, and built to serve the automotive fueling industry; and as such, these purposely built automotive fueling systems do not fill the needs of the mobile aviation fueling nor the mobile automotive fueling industries. There have been a few of these purposely built automotive fueling systems that have been adapted for use in mobile scenarios, but they lack the capabilities and features needed for a true mobile fueling system.

In a mobile scenario, the needs include: user and/or vehicle authorization and verification at a fueling truck, fueling control and accounting at the fueling truck, near real-time fueling transaction and data transfer to and from a host computer system, and fueling data analysis and distribution by the host computer. As previously mentioned, many of these features are available for fixed site (e.g. gas station) automotive fueling applications. However, none of the systems including these features fulfills the needs of the mobile aviation fueling or the mobile automotive fueling industries. There is a need for a purposely designed and tailored mobile fueling system to serve the mobile aviation fueling and mobile automotive fueling industries.

### SUMMARY OF THE INVENTION

The disclosed system has been purposely designed, tailored, and built to suit the mobile aviation and mobile automotive fueling industries. The disclosed system features: an intrinsically safe first programmed apparatus including a user interface, a second programmed apparatus for controlling fuel dispensing equipment, and a host computer system.

The intrinsically safe first programmed apparatus, which provides a user interface, allows a user to input all required authorization and billing data needed to initiate a fueling transaction. Means to input said data includes, but is not limited to: a touch screen LCD, a magnetic strip card reader, a contact tag reader/writer and, an EEPROM key type access device reader/writer. In addition to the input means, the intrinsically safe first programmed apparatus includes a first microprocessor and a first wireless communications transceiver. In the preferred embodiment of the disclosed system, the intrinsically safe first programmed apparatus would be located, for example, on the user's belt via a belt clip or in the user's pocket.

The second programmed apparatus for controlling the fuel dispensing equipment is composed of a microprocessor, a second wireless communications transceiver for communicating with the first wireless communications transceiver associated with the intrinsically safe first programmed apparatus, a third wireless communications transceiver, and an electrical control and data collection circuitry associated with mobile fuel dispensing equipment's control and data monitoring circuitry. In the preferred embodiment of the disclosed system, the second programmed apparatus would be located, for example, under a front seat in a cab of a fuel truck.

The second programmed apparatus for controlling the fuel dispensing equipment is also equipped with interfaces and controls for one or more fuel temperature sensors. The temperature sensor data is used to adjust dispensed fuel quantities based on a predetermined common temperature, which is usually 60° F.

The second programmed apparatus for controlling the fuel dispensing equipment is also equipped with interfaces and controls for one or more fuel control valves. The fuel control valves are used to restrict access to fuel dispensing or to allow access to fuel dispensing based on authorization data entered via the user interface of the first programmed apparatus. Further, the second programmed apparatus includes interfaces for controlling different types of valves, including, but not limited to: electric, hydraulic and air operated valves.

The second programmed apparatus for controlling the fuel dispensing equipment is also equipped with interfaces, which are preferably serial interfaces, for communication and operation of, but not limited to, a receipt printer and a charging/wired data transfer cradle for the intrinsically safe first programmed apparatus.

The host computer system is composed of at least one host computer and a fourth wireless communications transceiver for communicating with the third wireless communications transceiver associated with the second programmed apparatus. In the preferred embodiment of the disclosed system, the host computer system would be located, for example, in an airport fuels office or in operations shed of a strip mining operation.

The host computer system also equipped with interfaces, which are preferably serial and/or USB interfaces, for communication and operation of, but not limited to, a charging/wired data transfer cradle for the intrinsically safe first programmed apparatus.

Wireless communications between the first wireless communications transceiver and the second wireless communication transceiver are preferably composed of shorter range type communication equipment, such as Bluetooth. In contrast, the wireless communications between the third wireless communications transceiver and the fourth wireless communication transceiver are preferably composed of longer range frequency-hopping type equipment. Further, a communication range between the third and fourth wireless communications transceivers can be extended as necessary with repeaters composed of back-to-back third and fourth wireless communications transceivers operating independently and mounted as required to necessitate the communication range enhancement.

As a result of the structure of the present system, the present invention allows transaction data is stored, upon completion or termination of a fueling transaction, in the second programmed apparatus and then sent via the third and fourth wireless communications transceivers to the host computer system.

It is yet another feature of the disclosed system that commercial credit cards, such as, but not limited to, Master Card and Visa, can be accepted and verified from the intrinsically safe first programmed apparatus. A commercial credit card is read by the intrinsically safe first programmed apparatus's magnetic card reader. The captured commercial card data is then transferred to the second programmed apparatus via the first and second wireless communication transceivers and further transferred to the host computer systems via the third and fourth wireless communication transceivers. The host communication system transfers a credit card request to one of many commercial credit card networks for authorization. Upon the host computer system's receipt of authorization, the authorization is passed via the fourth and third wireless communication transceivers to the second programmed apparatus. Upon the second programmed apparatus's receipt of the authorization, the authorization is passed via the second and first wireless communication transceivers to the first programmed apparatus, and the mobile fuel dispensing equipment is activated via the second programmed apparatus's electrical control and data collection circuitry. Upon the first programmed apparatus's receipt of the authorization, acknowledgment of the authorization is passed via a display, such as an LCD display, to the user.

Upon completion of the commercial credit card authorized fueling transaction, the second programmed apparatus sends the fueling transaction data to the host computer system via the third and fourth wireless communication transceivers. Upon the host computer system's receipt of the completed transaction data, the host communication system will re-contact the credit card network from which the initial authorization for fuel was granted and transfer the completed fueling transaction data, which is usually referred to as a “settle up”. This settle up function is preferably accomplished in a batch mode at predetermined times or bases upon a predetermined batch size of a number of transactions.

### BRIEF DESCRIPTION OF THE DRAWINGS

A better understanding of the invention will be had with reference to the attached drawings, wherein:

FIG. 1 is a flow diagram illustrating the autonomous data collection and processing system for mobile fueling systems in accordance with the present invention;

FIG. 2 is a flow diagram illustrating the interconnection and the flow of control and data within a first programmed apparatus of the autonomous data collection and processing system of the present invention;

FIG. 3 is a flow diagram illustrating the interconnection and the flow of control and data within a second programmed apparatus of the autonomous data collection and processing system;

FIG. 4 is a flow diagram illustrating the interconnection and the flow of control and data within a truck charger/data cradle and printer of the autonomous data collection and processing system;

FIG. 5 is a flow diagram illustrating the interconnection and the flow of control and data within a desk charger/data cradle of the autonomous data collection and processing system;

FIG. 6 is a flow diagram illustrating the interconnection and the flow of control and data within the host computer system of the autonomous data collection and processing system; and

FIG. 7 is a perspective view of a fuel truck equipped with the first programmed apparatus and the second programmed apparatus in accordance with a preferred embodiment of the present invention.

### DETAILED DESCRIPTION OF PREFERRED EMBODIMENTS

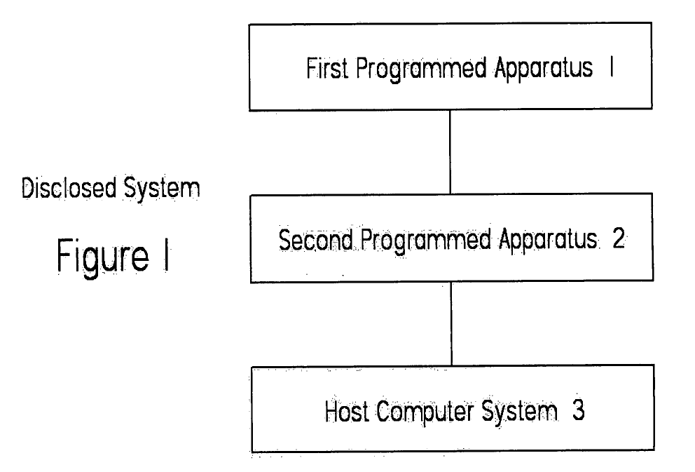

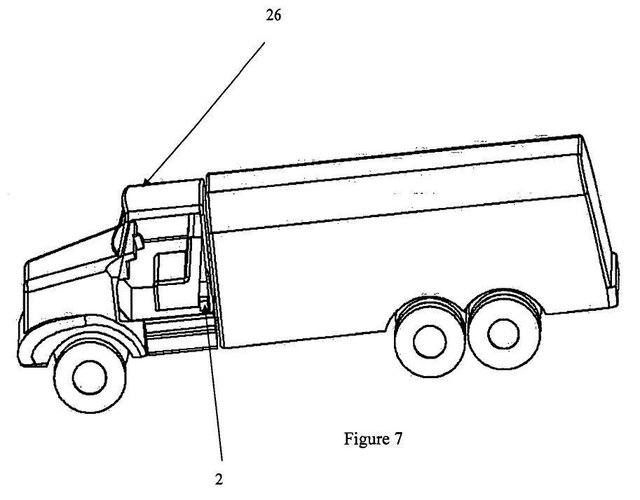

Referring to FIG. 1, an apparatus and method for autonomous data collection and processing of fuel transactions from mobile tanker trucks in accordance with a preferred embodiment of the present invention comprise a first programmed apparatus 1, a second programmed apparatus 2, and a host computer system 3. The apparatus and system further comprise a truck charger/data cradle 26 and a desk charger/data cradle 32. Communications between the parts of the disclosed system are bi-directional. The first programmed apparatus 1 preferably clips onto a user's belt or pocket, and the truck charger data cradle 26 can be secured to a dashboard of a fuel truck, as shown in FIG. 7. The second programmed apparatus 2 is preferably located under a front seat in a cab of a fuel truck, as also shown in FIG. 7, and the host computer system 3 is preferably located at an airport fuels office.

In the preferred embodiment, a user would enter fueling access authorization data via an access media. The fueling access authorization data would then be verified by a local authorization at the first programmed apparatus 1, at the second programmed apparatus 2, or at the host computer system 3. The host computer system 3 can either locally authorize a fueling transaction or use one of many commercial host systems for verifying commercial magnetic strip cards, such as, but not limited to, Master Card and Visa.

Once a fuel transaction has been authorized, the first programmed apparatus 1 notifies the user that fueling can commence, and the second programmed apparatus 2 allows activation of the fueling controls of a fuel vehicle. The second programmed apparatus 2 initiates a fueling transaction and monitors the transaction for quantity and fuel temperature throughout the transaction. Upon termination of the transaction, the second programmed apparatus 2 stores the transaction data and sends the stored transaction data to the host computer system 3.

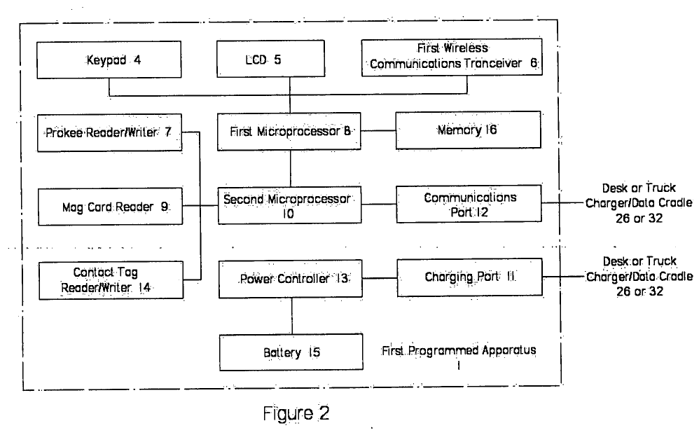

The first programmed apparatus 1 is shown in FIG. 2. In the preferred embodiment, the first programmed apparatus 1 provides a user interface to allow a user to input all required authorization and billing data needed to initiate a fueling transaction. The user interface includes means for inputting data includes a keypad 4, an LCD screen 5, a Prokee® reader/writer 7, a magnetic strip card reader 9, and a contact tag reader/writer 14.

The first programmed apparatus 1 further includes a first microprocessor 8, a second microprocessor 10, and power management circuitry 13. The power management circuitry 13 controls, regulates, and distributes power to each of the components of the first programmed apparatus 1. Further, the power management circuitry 13 receives power from a battery 15 and receives additional power from a charging port 11. The charging port 11 receives power from either a desk charger/data cradle 26 or a truck charger/data cradle 32 upon physical insertion of the first programmed apparatus 1 into either cradle 26 or 32.

The second microprocessor 10 controls, manages, and configures data to and from the Prokee® reader/writer 7, the magnetic strip card reader 9, the contact tag reader/writer 14, and a communications port 12. The second microprocessor 10 communicates managed and configured data to and from the first microprocessor 8, which communicates with and controls a keypad 4, an LCD 5, and a first wireless communications transceiver 6.

When fueling access authorization data is received by the Prokee® reader/writer 7, the magnetic strip card reader 9, or the contact tag reader/writer 14, the second microprocessor 10 processes the data and passes the data to the first microprocessor 8. When access authorization data may is entered via the keypad 4 or the LCD 5, the fueling access authorization data is received and processed by the first microprocessor 8 directly. Initial verification for received data is accomplished by comparing the received data with data stored in a memory 16.

Upon successful receipt and initial verification of the fueling access authorization data, the fueling access authorization data is transmitted via the first wireless communications transceiver 6 to a second wireless communications transceiver 17 of the truck charger/data cradle 26 of the first programmed apparatus 1. Since all communications of the system of the present invention are bi-directional, the first programmed apparatus 1 via the first wireless communications transceiver 6 and the first microprocessor 8 also receives data from the second wireless communications transceiver 17. The data received from the second wireless communications transceiver 17 can be displayed to a user on the LCD 5 and can be used to update the data stored in the memory 16.

As an alternative to wireless communications, the autonomous data collection and processing system and apparatus of the present invention can utilize two non-wireless data transfer methods. The first programmed apparatus 1 can be inserted into the truck charger/data cradle 32 for non-wireless data transfer to the second programmed apparatus 2. Further, the first programmed apparatus 1 can be inserted into the desk charger/data cradle 32 for non-wireless data transfer to the host computer system 3.

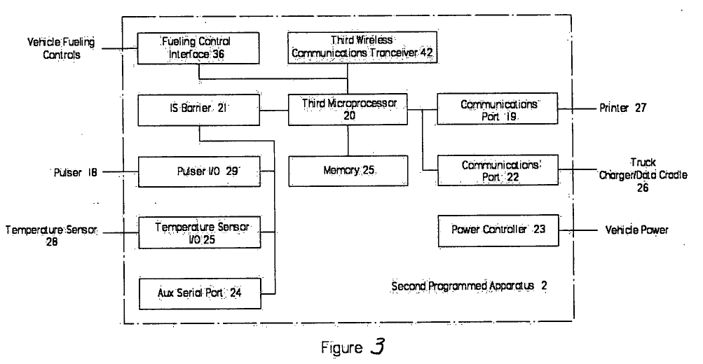

Referring to FIG. 3, the second programmed apparatus 2 comprises a third microprocessor 20, a third wireless communications transceiver 42, a memory 25, power management circuitry 23, an intrinsically safe (IS) barrier 21, and multiple I/O ports. The power management circuitry 23 receives power from the vehicle, and the power management circuitry 23 controls, regulates and distributes power to each of the components of second programmed apparatus 2.

An auxiliary communications port 24, a vehicle pulser 18, and a fuel temperature sensor 28 are accessed, controlled, and/or monitored by the third microprocessor 20 via the IS barrier 21, a pulser I/O 29, and a temperature sensor I/O 25. The third microprocessor 20 also controls the vehicle's fuel flow valves via a fueling control interface 36.

Data is transferred to and from the host computer system 3 via the third wireless communications transceiver 42. Data is also transferred to and from the first programmed apparatus 1 via a communications port 22, the truck charger/data cradle 26, and the second wireless communications transceiver 17. Data storage within the second programmed apparatus 2 is accomplished by the third microprocessor 20 and the memory 25.

In the preferred embodiment, the second programmed apparatus 2 is the controlling entity for the autonomous data collection and processing system and apparatus. With the second programmed apparatus 2 being the controlling entity for the apparatus and system, the first programmed apparatus 1 needs only to collect the authorization data and transmit the authorization data to the second programmed apparatus 2. The first programmed apparatus 1 may then turn off or go to a reduced power mode, which is usually referred to as a “sleep mode.” The second programmed apparatus 2 will then run the transaction, record the transaction data, and transfer the transaction data to the host computer system 3.

Also in the preferred embodiment, the primary means of data transfer from the fueling vehicle, where the second programmed apparatus 2 is located, to a fuels office, where the host computer system 3 is preferably located, is via the third wireless communications transceiver 42 associated with the second programmed apparatus 2 and a fourth wireless communications transceiver 41 associated with the host computer system 3.

As an alternative for transferring data from the fueling vehicle to the fuels office, data can be first transferred from the second programmed apparatus 2 to the first programmed apparatus 1, and then the first programmed apparatus 1 can transfer the data to the host computer system 3. There are two ways to transfer the data from the second programmed apparatus 2 to the first programmed apparatus 1. First, data can be wirelessly transferred between the second wireless communications transceiver 17 and the first wireless communications transceiver 6 of the first programmed apparatus 1. Second, the data can be non-wirelessly transferred between a first programmed apparatus interface 31 of the truck charger/data cradle 26 and the first programmed apparatus 1. After the data is received by the second programmed apparatus 2, either wirelessly or non-wirelessly, the data is uploaded to the host computer system 3 via the first programmed apparatus interface 39 of the desk charger/data cradle 32.

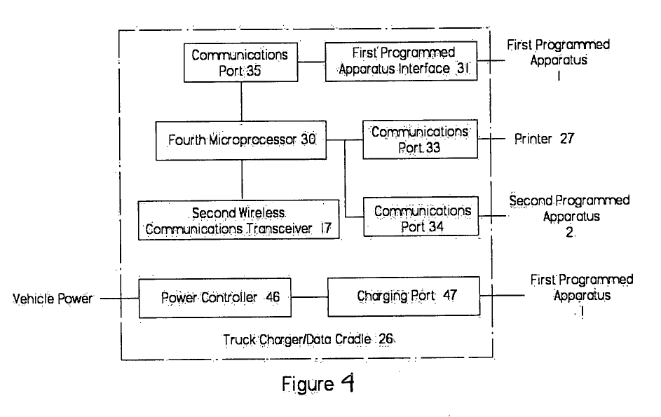

Referring to FIG. 4, the truck charger/data cradle 26 comprises a fourth microprocessor 30, the second wireless communication transceiver 17, multiple communications ports, power management circuitry 46, and the first programmed apparatus interface 31. The power management circuitry 46 receives power from the vehicle's power, and the power management circuitry 46 controls, regulates, and distributes power to each of the components of the truck charger/data cradle 26. Additionally, the power management circuitry 46 supplies power to the first programmed apparatus 1 via a charging port 47. The power supplied to the first programmed apparatus 1 is used by the first programmed apparatus 1 and the power management circuitry 13 to charge the battery 15.

The fourth microprocessor 30 of the truck charger/data cradle 26 is on a wired serial bus of the third microprocessor 20 of the second programmed apparatus 2. The truck charger/data cradle 26 uses a communications port 34 to implement its node on a bus of the fourth microprocessor 30 to the third microprocessor 20.

The fourth microprocessor 30 sends and receives data via the second wireless communications transceiver 17 from the first wireless communications transceiver 6 of the first programmed apparatus 1. Alternately, the fourth microprocessor 30 sends and receives data via the first programmed apparatus interface 31 from the communications port 12 of the first programmed apparatus 1. Wired bus and wireless communications sent and received data can include, but are not limited to: transfer of transaction data, transfer of authorization data, transfer of authorization lock lists, and transfer of program update data.

A printer 27 is physically wired to the fourth microprocessor 30 of the truck charger/data cradle 26 via a communications port 33. The first microprocessor 8, the third microprocessor 20, the fourth microprocessor 30, and the printer 27 are all attached to the aforementioned communications bus, and, as such, all microprocessors 8, 20, and 30 can access the printer 27.

In the preferred embodiment, the truck charger/data cradle 26 is located in the physical place where the first programmed apparatus 1 is stored. When the first programmed apparatus 1 is placed in the truck charger/data cradle 26, the battery 15 of first programmed apparatus 1 can be charged, and data can be bi-directionally transferred between the first programmed apparatus 1, the second programmed apparatus 2, the host computer system 3, and the printer 27.

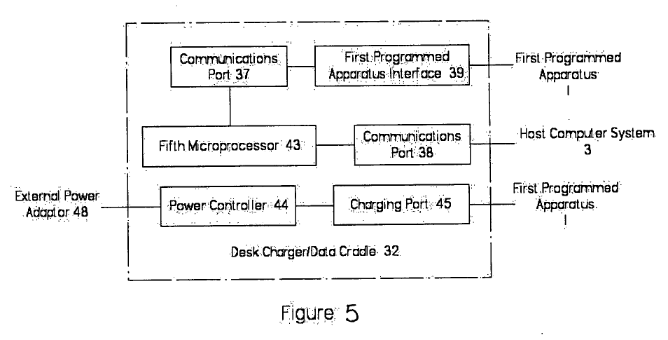

Referring to FIG. 5, the desk charger/data cradle 32 comprises the fifth microprocessor 43, communications ports 37 and 38, power management circuitry 44, and the first programmed apparatus interface 39. The power management circuitry 44 receives power from an external power adaptor 48, and the power management circuitry 44 controls, regulates, and distributes power to each of the components of the desk charger/data cradle 32. Additionally, the power management circuitry 44 supplies power to the first programmed apparatus 1 via a charging port 45. The power supplied to the first programmed apparatus 1 is used by the first programmed apparatus 1 and the power management circuitry 13 to charge the battery 15.

The fifth microprocessor 43 of the desk charger/data cradle 32 communicates with the first programmed apparatus 1 via the communications port 37 and the first programmed apparatus interface 39. Additionally, the fifth microprocessor 43 of the desk charger/data cradle 32 communicates with the host computer system 3 via the communications port 38.

In the preferred embodiment, the desk charger/data cradle 32 is located at the physical place where the first programmed apparatus 1 is stored. When the first programmed apparatus 1 is placed in the desk charger/data cradle 32, the battery 15 of the first programmed apparatus 1 can be charged, and data can be bi-directionally transferred between the first programmed apparatus 1 and the host computer system 3.

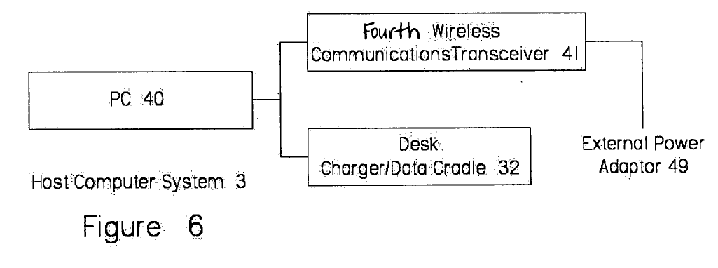

Referring to FIG. 6, the host computer system 3 comprises at least one personal computer 40, the fourth wireless communications transceiver 41, and the desk charger/data cradle 32. The personal computer 40 is in wireless communication with the second programmed apparatus 2 via the fourth wireless communications transceiver 41. The personal computer is also in wired communication with the first programmed apparatus 1 via the desk charger/data cradle 32. The personal computer 40 also communicates wirelessly with the first programmed apparatus 1 via the fourth wireless communications transceiver 41 and second programmed apparatus 2.

In the preferred embodiment, the personal computer 40 gathers data from the first programmed apparatus 1 and the second programmed apparatus 2, supplies data to the first programmed apparatus 1 and the second programmed apparatus 2, and provides both raw and analyzed data to system administrators, owners, and users of the disclosed system.

The foregoing description of the present invention has been presented to illustrate the principles of the invention and not to limit the invention to the particular embodiments illustrated. It is intended that the scope of the invention be defined by all of the embodiments encompassed within the following claims and their equivalents.

We claim:

1. An apparatus for autonomous data collection and processing of fuel transactions for a mobile fuel system, comprising:
a) a first programmed apparatus configured to provide fuel data input and a user interface;
b) a second programmed apparatus configured to provide control for fuel dispensing equipment; and
c) a host computer system configured to provide reception, accounting, and analysis of fuel data.

2. The apparatus for autonomous data collection and processing of fuel transactions for a mobile fuel system of claim 1, wherein said first programmed apparatus includes:
a) a first microprocessor programmed to accommodate user input, to provide user information, and to process data;
b) a user interface means configured to receive user input;
c) a memory configured to provide storage for fuel data;
d) a first communications port configured to provide bi-directional transfer of fuel data;
e) a first wireless communications transceiver configured to provide bi-directional wireless transfer of fuel data; and
f) a battery and first power management circuitry to provide power to all components of said first programmed apparatus.

3. The apparatus for autonomous data collection and processing of fuel transactions for a mobile fuel system of claim 2, further comprising display means for displaying fuel data to a user.

4. The apparatus for autonomous data collection and processing of fuel transactions for a mobile fuel system of claim 3, wherein said display means is a liquid crystal display (LCD).

5. The apparatus for autonomous data collection and processing of fuel transactions for a mobile fuel system of claim 2, wherein said user interface means is:
a) a liquid crystal display (LCD) with touch screen capabilities,
b) a keypad,
c) a magnetic strip card reader,
d) a contact tag reader/writer; or
e) an EEPROM based data key reader/writer.

6. The apparatus for autonomous data collection and processing of fuel transactions for a mobile fuel system of claim 2, wherein said first microprocessor is in electronic communication with said user interface means, said memory, said first communications port; and said first wireless communications transceiver.

7. The apparatus for autonomous data collection and processing of fuel transactions for a mobile fuel system of claim 1, wherein said second programmed apparatus includes:
a) a second microprocessor programmed to accommodate fuel accounting and control;
b) a second wireless communications transceiver configured to provide bi-directional wireless transfer of fuel data;
c) a memory configured to provide storage for fuel data;
d) second communication ports configured to provide bi-directional transfer of fuel data;
e) electrical control and data collection circuitry configured to interface fuel dispensing equipment; and
f) second power management circuitry to provide power to all components of said second programmed apparatus.

8. The apparatus for autonomous data collection and processing of fuel transactions for a mobile fuel system of claim 7, wherein said second microprocessor is in electronic communications with said second wireless communications transceiver, said second communication ports configured to provide bi-directional transfer of data, said electrical control and data collection circuitry; and said memory.

9. The apparatus for autonomous data collection and processing of fuel transactions for a mobile fuel system of claim 7, wherein said electrical control and data collection circuitry has:
a) a pulser for counting fuel quantity;
b) a fuel temperature sensor for adjusting fuel temperature to a common standard; and
c) fuel dispensing control circuitry for controlling the flow of fuel from fuel dispensing equipment.

10. The apparatus for autonomous data collection and processing of fuel transactions for a mobile fuel system of claim 7, wherein said second communication ports transfer data to a receipt printer and a charging/data transfer cradle.

11. The apparatus for autonomous data collection and processing of fuel transactions for a mobile fuel system of claim 1, further comprising a receipt printer.

12. The apparatus for autonomous data collection and processing of fuel transactions for a mobile fuel system of claim 1, further comprising a charging/data transfer cradle.

13. The apparatus for autonomous data collection and processing of fuel transactions for a mobile fuel system of claim 12, wherein said charging/data transfer cradle includes:
a) a cradle microprocessor programmed to accommodate fuel data transfer,
b) a cradle wireless communications transceiver configured to provide bi-directional wireless transfer of fuel data,
c) cradle communications ports configured to provide bi-directional transfer of fuel data; and
d) cradle power management circuitry to provide power to all components of said first charging/data transfer cradle.

14. The apparatus for autonomous data collection and processing of fuel transactions for a mobile fuel system of claim 13, wherein said cradle communications ports are configured to communicate with said first programmed apparatus and said second programmed apparatus.

15. The apparatus for autonomous data collection and processing of fuel transactions for a mobile fuel system of claim 1, wherein said host computer system includes:
a) at least one host computer programmed and configured to provide reception, accounting, analysis, and distribution of fuel data;
b) a host wireless communications transceiver configured to provide bi-directional wireless transfer of fuel data; and
c) a host charging/data transfer cradle.

16. The apparatus for autonomous data collection and processing of fuel transactions for a mobile fuel system of claim 15, wherein said at least one host computer is in electronic communications with said host wireless communications transceiver and said host charging/data transfer cradle.

17. The apparatus for autonomous data collection and processing of fuel transactions for a mobile fuel system of claim 15, wherein said host charging/data transfer cradle has:
a) a host cradle microprocessor programmed to accommodate fuel data transfer;
b) host cradle communications ports configured to provide bi-directional transfer of fuel data; and
c) host cradle power management circuitry.

18. The apparatus for autonomous data collection and processing of fuel transactions for a mobile fuel system of claim 17, wherein said host cradle communications ports are configured to communicate with said first programmed apparatus and said host computer system.

19. The apparatus for autonomous data collection and processing of fuel transactions for a mobile fuel system of claim 2, wherein said second programmed apparatus includes:
a) a second microprocessor programmed to accommodate fuel accounting and control;
b) a second wireless communications transceiver configured to provide bi-directional wireless transfer of fuel data;
c) a memory configured to provide storage for fuel data;
d) second communication ports configured to provide bi-directional transfer of fuel data;
e) electrical control and data collection circuitry configured to interface fuel dispensing equipment; and
f) second power management circuitry to provide power to all components of said second programmed apparatus.

20. The apparatus for autonomous data collection and processing of fuel transactions for a mobile fuel system of claim 19, wherein said first wireless communications transceiver is in bi-directional communication with said second wireless communications transceiver.

21. The apparatus for autonomous data collection and processing of fuel transactions for a mobile fuel system of claim 19, wherein said host computer system includes:
a) at least one host computer programmed and configured to provide reception, accounting, analysis, and distribution of fuel data;
b) a host wireless communications transceiver configured to provide bi-directional wireless transfer of fuel data; and
c) a host charging/data transfer cradle.

22. The apparatus for autonomous data collection and processing of fuel transactions for a mobile fuel system of claim 21, wherein said second wireless communications transceiver is in bi-directional communication with said host wireless communications transceiver.

23. A method for autonomous data collection and processing of fuel transactions for a mobile fuel system, comprising:
a) collecting mobile fuel truck fuel authorization data;
b) verifying fuel authorization data;
c) authorizing a fuel transaction; and
d) providing real time fueling data to a user.

24. The method for autonomous data collection and processing of fuel transactions for a mobile fuel system of claim 23, further comprising printing fuel data.

25. The method for autonomous data collection and processing of fuel transactions for a mobile fuel system of claim 23, wherein said collecting mobile fuel truck fuel authorization data includes using a first programmed apparatus, said first programmed apparatus having:
a) a first microprocessor programmed to accommodate user input, to provide user information, and to process fuel data;
b) a user interface means configured to receive user input;
c) a memory configured to provide storage for fuel data;
d) a first communications port configured to provide bi-directional transfer of fuel data;
e) a first wireless communications transceiver configured to provide bi-directional wireless transfer of fuel data; and
f) a battery and first power management circuitry to provide power to all components of said first programmed apparatus.

26. The method for autonomous data collection and processing of fuel transactions for a mobile fuel system of claim 25, wherein said user interface means is:
a) a liquid crystal display (LCD) with touch screen capabilities,
b) a keypad,
c) a magnetic strip card reader,
d) a contact tag reader/writer; or
e) an EEPROM based data key reader/writer.

27. The method for autonomous data collection and processing of fuel transactions for a mobile fuel system of claim 23, wherein said verifying fuel authorization data includes using a second programmed apparatus having:
a) a second microprocessor programmed to accommodate fuel accounting and control;
b) a second wireless communications transceiver configured to provide bi-directional wireless transfer of fuel data;
c) a memory configured to provide storage for fuel data;
d) second communication ports configured to provide bi-directional transfer of fuel data;
e) electrical control and data collection circuitry configured to interface fuel dispensing equipment; and
f) second power management circuitry to provide power to all components of said second programmed apparatus.

28. The method for autonomous data collection and processing of fuel transactions for a mobile fuel system of claim 27, wherein said electrical control and data collection circuitry has:
a) a pulser for counting fuel quantity;
b) a fuel temperature sensor for adjusting fuel temperature to a common standard; and
c) fuel dispensing control circuitry for controlling the flow of fuel from fuel dispensing equipment.

29. The method for autonomous data collection and processing of fuel transactions for a mobile fuel system of claim 25, wherein said verifying fuel authorization data includes using a second programmed apparatus having:
a) a second microprocessor programmed to accommodate fuel accounting and control;
b) a second wireless communications transceiver configured to provide bi-directional wireless transfer of fuel data;
c) a memory configured to provide storage for fuel data;
d) second communication ports configured to provide bi-directional transfer of fuel data;
e) electrical control and data collection circuitry configured to interface fuel dispensing equipment; and
f) second power management circuitry to provide power to all components of said second programmed apparatus.

30. The method for autonomous data collection and processing of fuel transactions for a mobile fuel system of claim 25, wherein first wireless communications transceiver is in bi-directional communication with said second wireless communications transceiver.

31. The method for autonomous data collection and processing of fuel transactions for a mobile fuel system of claim 23, wherein said verifying fuel authorization data includes using a host computer system having:
a) at least one host computer programmed and configured to provide reception, accounting, analysis, and distribution of fuel data;
b) a host wireless communications transceiver configured to provide bi-directional wireless transfer of fuel data; and
c) a host charging/data transfer cradle.

32. The apparatus for autonomous data collection and processing of fuel transactions for a mobile fuel system of claim 31, wherein said host charging/data transfer cradle has:
a) a host cradle microprocessor programmed to accommodate fuel data transfer;
b) host cradle communications ports configured to provide bi-directional transfer of fuel data; and
c) host cradle power management circuitry.

33. The method for autonomous data collection and processing of fuel transactions for a mobile fuel system of claim 29, wherein said verifying fuel authorization data includes using a host computer system having:
a) at least one host computer programmed and configured to provide reception, accounting, analysis, and distribution of fuel data;
b) a host wireless communications transceiver configured to provide bi-directional wireless transfer of fuel data; and
c) a host charging/data transfer cradle.

34. The apparatus for autonomous data collection and processing of fuel transactions for a mobile fuel system of claim 33, wherein said second wireless communications transceiver is in bi-directional communication with said host wireless communications transceiver.

35. The method for autonomous data collection and processing of fuel transactions for a mobile fuel system of claim 23, wherein said authorizing a fuel transaction includes using a second programmed apparatus having:
a) a second microprocessor programmed to accommodate fuel accounting and control;
b) a second wireless communications transceiver configured to provide bi-directional wireless transfer of fuel data;
c) a memory configured to provide storage for fuel data;
d) second communication ports configured to provide bi-directional transfer of fuel data;
e) electrical control and data collection circuitry configured to interface fuel dispensing equipment; and
f) second power management circuitry to provide power to all components of said second programmed apparatus.

36. The method for autonomous data collection and processing of fuel transactions for a mobile fuel system of claim 35, wherein said electrical control and data collection circuitry has:
a) a pulser for counting fuel quantity;
b) a fuel temperature sensor for adjusting fuel temperature to a common standard; and
c) fuel dispensing control circuitry for controlling the flow of fuel from fuel dispensing equipment.

37. The method for autonomous data collection and processing of fuel transactions for a mobile fuel system of claim 25, wherein said authorizing a fuel transaction data includes using a second programmed apparatus having:
a) a second microprocessor programmed to accommodate fuel accounting and control;
b) a second wireless communications transceiver configured to provide bi-directional wireless transfer of fuel data;
c) a memory configured to provide storage for fuel data;
d) second communication ports configured to provide bi-directional transfer of fuel data;
e) electrical control and data collection circuitry configured to interface fuel dispensing equipment; and
f) second power management circuitry to provide power to all components of said second programmed apparatus.

38. The method for autonomous data collection and processing of fuel transactions for a mobile fuel system of claim 37, wherein first wireless communications transceiver is in bi-directional communication with said second wireless communications transceiver.

39. The method for autonomous data collection and processing of fuel transactions for a mobile fuel system of claim 23, wherein said authorizing a fuel transaction includes using a host computer system having:
a) at least one host computer programmed and configured to provide reception, accounting, analysis, and distribution of fuel data;
b) a host wireless communications transceiver configured to provide bi-directional wireless transfer of fuel data; and
c) a host charging/data transfer cradle.

40. The apparatus for autonomous data collection and processing of fuel transactions for a mobile fuel system of claim 39, wherein said host charging/data transfer cradle has:
a) a host cradle microprocessor programmed to accommodate fuel data transfer;
b) host cradle communications ports configured to provide bi-directional transfer of fuel data; and
c) host cradle power management circuitry.

41. The method for autonomous data collection and processing of fuel transactions for a mobile fuel system of claim 35, wherein said verifying fuel authorization data includes using a host computer system having:
a) at least one host computer programmed and configured to provide reception, accounting, analysis, and distribution of fuel data;
b) a host wireless communications transceiver configured to provide bidirectional wireless transfer of fuel data; and
c) a host charging/data transfer cradle.

42. The apparatus for autonomous data collection and processing of fuel transactions for a mobile fuel system of claim 41, wherein said second wireless communications transceiver is in bi-directional communication with said host wireless communications transceiver.
